(19) United States
(12) Patent Application Publication
(10) Pub. No.: US 2003/0136061 A1
(43) Pub. Date: Jul. 24, 2003

(54) Telescopical device

(76) Inventor: Jorgen Larsen, Skaelskor (DK)

Correspondence Address: HARNESS, DICKEY & PIERCE, P.L.C., P.O. BOX 8910, RESTON, VA, 20195, US

(21) Appl. No.: 10/240,042

(22) PCT Filed: Mar. 30, 2001
(86) PCT No.: PCT/DK01/00216

(30) Foreign Application Priority Data
Mar. 31, 2000 (DK) PA 2000 00541

(51) Int. Cl. E04H 12/34; B66C 23/06; B66C 23/62

(52) U.S. Cl. 52/111

(57) ABSTRACT

A bar or column shaped telescopic device comprising at least three telescopic parts with a first part (3), a middle part (2) and a second part (1), that are in telescopic engagement with each other. A first (4) and a second (7) adjusting screw extend inside the telescopic parts, and the first adjusting screw is connected to the first telescopic part (3) and is in threaded engagement with a nut (5) mounted onto the middle telescopic part (2) in such a way that said nut (5) is turnable about the longitudinal axis of the first adjusting screw. The second adjusting screw (7) is connected to but turnable in relation to the middle telescopic part (2) and in threaded engagement with the second telescopic part (1) via a nut (8). The device comprises driving means (11) for rotating the nut (5) and the second adjusting screw (7) simultaneously.

The invention relates to a telescopic device with at least three telescopic parts in engagement with each other and comprising adjusting screws and driving means for telescopic displacement of the telescopic parts in relation to each other, thus enabling usage of the device for e.g. height adjustment of tables.

### BACKGROUND OF THE INVENTION

Various telescopic devices are known from patent literature, including U.S. Pat. No. 4,651,581, U.S. Pat. No. 4,793,197, U.S. Pat. No. 5,660,495 and WO 99/52739.

### SUMMARY OF THE INVENTION

It is an object of the present invention to provide a telescopic device for e.g. height adjustment of tables, and wherein the telescopic parts are slidably arranged in each other in a compact manner in order that the device obtains a small building-in height/length in relation to the travel of the telescopic parts.

This is obtained according to the invention by means of a bar or column shaped telescopic device comprising:

at least three telescopic parts with a first part, a middle part and a second part, the telescopic parts being in telescopic engagement with each other,

a first and a second adjusting screw extending inside the telescopic parts, the first adjusting screw being connected to the first telescopic part and in threaded engagement with a nut mounted onto the middle telescopic part in such a way that said nut is turnable about the longitudinal axis of the first adjusting screw, while the second adjusting screw is connected to but turnable in relation to the middle telescopic part and in threaded engagement with the second telescopic part, and

driving means for rotating the nut and the second adjusting screw simultaneously.

The adjusting screws may be provided with an outer spiral thread, the nut being displaceable about the longitudinal axis of the first adjusting screw, and the second adjusting screw is preferably in threaded engagement with the second telescopic part via a nut attached to the second telescopic part in such a way that the nut is displaced axially along the second adjusting screw upon rotation of this adjusting screw.

Preferably, the at least three telescopic parts are substantially of the same length. However, they may be of different lengths depending on where the device is to be built in and on the extent of travel required for the telescopic parts.

To displace the telescopic parts telescopically in relation to each other the driving means preferably comprise a driving part arranged in the middle telescopic part, the driving part being in driving engagement with the nut and the second adjusting screw in such a way that these are rotated simultaneously when the driving part rotates. Preferably, the nut has the form of a first toothed wheel, one end of the second adjusting screw is attached to a second toothed wheel and the driving part comprises a driving toothed wheel, the first and the second toothed wheel being in direct or indirect engagement with the driving toothed wheel in such a way that these rotates upon rotation of the driving toothed wheel.

An advantage of this device is that the first telescopic part and the middle telescopic part are displaced synchronously and thus, the device obtains a very small building-in height/length in relation to the travel of the telescopic parts.

To drive the driving toothed wheel the telescopic device may comprise a telescopic driving shaft (transmission shaft) extending into the telescopic parts in the longitudinal direction and connecting the driving toothed wheel to a power source provided outside the telescopic parts. In a preferred embodiment the power source comprises an electrically driven motor which is in engagement with the driving toothed wheel via the driving shaft. The motor is preferably arranged in the top of the telescopic device and the driving shaft thus extends downwards through the upper telescopic part and into the middle telescopic part, the driving toothed wheel, the first and the second toothed wheel being arranged preferably in e.g. a gear box positioned in the lower end of the middle telescopic part. The driving shaft may be divided into one or several parts which may all be provided with complementary inner and outer, respectively, non-circular, preferably edged, cross sections or oval shaped cross sections in telescopic engagement with each other, these parts being unable to rotate in relation to each other.

In a particular embodiment the power source drives both the nut and the second adjusting screw, but the nut and the second adjusting screw may be driven by separate power sources and the power sources may be mounted directly onto the nut and the adjusting screw or they may be in indirect engagement with these via toothed wheels, belts or chains. The power sources may be arranged in one or several of the telescopic parts.

Alternatively, the power source(s) may comprise a pneumatically driven motor or it may comprise manually driven devices such as a crank handle being engaged with the driving shaft. Since the device is meant for e.g. height adjustment of tables with typically at least one telescopic device arranged at each side of the table, each telescopic device may have separate power sources or they may be driven by the same power source which may be connected to each of these via e.g. belt drives or gear with the power source being manually or electrically or pneumatically driven.

The driving means, the first toothed wheel and the second toothed wheel are preferably arranged in one end of the middle telescopic part. Alternatively, they may be arranged in one of the other telescopic parts or arranged on an outer side of one or several of the telescopic parts, the driving means thus driving the nut and the second adjusting screw via openings in the telescopic parts. The openings may comprise slots extending downwards along the telescopic parts and through which e.g. driving toothed wheels may engage with the nut and/or the second adjusting screw and/or other driving means.

The telescopic device may comprise more than three telescopic parts in telescopic engagement with each other, such as four, five, six, seven or more, and the device may in that case comprise several adjusting screws, nuts, driving shafts and toothed wheels to displace the telescopic parts telescopically in relation to each other. The driving shafts may be driven manually or electrically or pneumatically or by combinations of these. The power source may drive all nuts and adjusting screws, but the nuts and the adjusting screws may alternatively be driven by separate power sources.

To prevent the at least three or more telescopic parts from rotating in relation to each other they may have an outer non-circular, preferably edged, cross section or oval shaped cross section. In addition, the telescopic parts may have inner and outer recesses, respectively, in telescopic engagement with each other such as slots or other devices preventing the telescopic parts from rotating in relation to each other even if these have an outer circular cross section. Further, the telescopic device may be mounted onto a fixed foot/base to avoid rotation of the device on e.g. a floor.

In order to avoid clearance between the telescopic parts, the device may further comprise sleeves extending along at least a part the outer surface of the second and middle telescopic part, respectively, and fitting into the middle and first telescopic part, respectively. Preferably, the sleeve surrounds the telescopic part and extends along a substantial part of the outer surface thereof.

Each sleeve may comprise one or more expansible tube-like channel(s) arranged on one or more sides of the sleeve. Preferably, the channels are arranged horizontally and surround the sleeve in its upper and/or lower portion, but they can be arranged in any way along the sides of the sleeve, such as vertically and/or crosswise from the lower to the upper portion.

Instead of channels the sleeve may comprise pockets arranged on the sides of the sleeves, and which may contain expansible material.

Due to said sleeves it is easy to obtain the preferred tolerance between the telescopic part as it only depends on how much the channels are expanded.

Preferably, the channels are expanded by filling them with an expansible material, such as foamed plastic. The expansible material can be filled in through pipe stubs provided in each end of the channel. The pipe stubs may protrude through holes provided in the sidewall of the telescopic part, which it is fitted into, and thus ensure that the sleeve is maintained to that telescopic part.

Alternatively, each channel may be expanded either by heating up a material that is pre-arranged in the channel and which expands under high temperature or by mixing reagents within the channel, said mixing provides the expansion.

Preferably, the sleeves are made of a flexible material, such as plastic.

The length of each telescopic part may vary depending on the device's field of application, which may e.g. be car lifts, tables, chairs or other devices requiring long or short travel. The length of each telescopic part may vary from below 1 cm and up to above 200 cm. Due to the design of the driving arrangement of the telescopic device very long travel in relation to the building-in height is obtained. If the device is used for height adjustment of tables, it will meet the requirement that it should be able to lift the table a minimum distance of 60 cm in order that the table may be lifted from a height of 60 cm to minimum a height of 120 cm.

The telescopic device may be designed in such a way that each telescopic part may be displaced telescopically between 0 cm and 200 cm, such as between 20 cm and 180 cm, such as between 40 cm and 160 cm, such as between 60 cm and 140 cm, such as between 80 cm and 120 cm. The telescopic device may also be designed in such a way that each telescopic part may be displaced more than 200 cm.

Further, the telescopic device may be surrounded by a covering. Preferably, a covering is arranged on each telescopic part, these coverings being moved synchronously with the telescopic parts when these are displaced in relation to each other. Alternatively, the covering may comprise one overall covering which may be formed of a resilient material and thus move up and down along the outer surface of the telescopic device when the telescopic parts are displaced up and down.

The telescopic device according to the invention may be applied in several different connections where the need for height/length adjustment exists, such as height adjustment of tables, chairs, lifts, including car lifts, lifts for handicap equipment etc.

### BRIEF DESCRIPTION OF THE FIGURES

A preferred embodiment of the invention will be described in details below with reference to FIGS. 1-15, in which

FIGS. 1-2 show a telescopic device in three different positions,

FIG. 3 shows a top view of a telescopic device with a gearbox,

FIGS. 4-6 show toothed wheels according to the invention,

FIG. 7 shows a gearbox within a housing,

FIGS. 8-10 show adjusting screws according to the invention,

FIGS. 11-12 show telescopic parts according to the invention,

FIG. 13 shows a bottom plate for a telescopic part,

FIGS. 14a-d show a sleeve according to the invention, and

FIG. 15 shows a telescopic part comprising a sleeve.

### DETAILED DESCRIPTION OF THE FIGURES

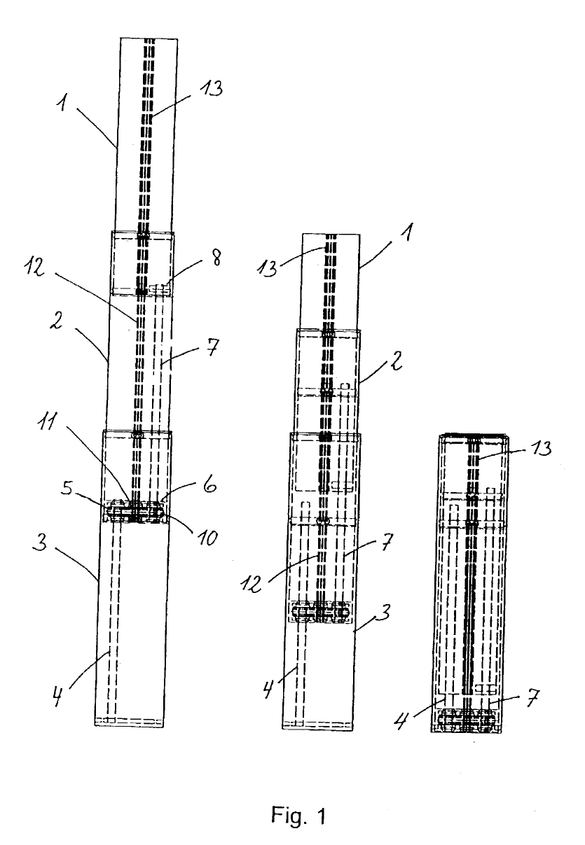

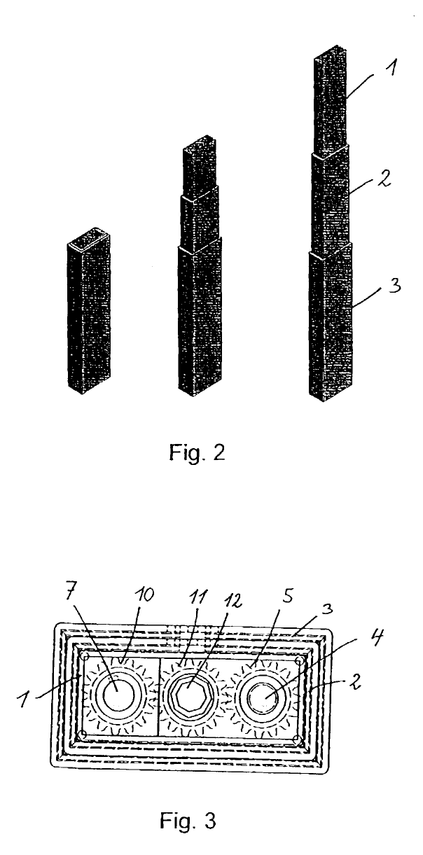

In FIGS. 1-2 a telescopic device comprising three telescopically engaging telescopic parts 1, 2 and 3, is shown in a highest, middle and lowest condition, respectively. The telescopic part 3 comprises a first adjusting screw (or spindle) 4 which is attached to the telescopic part 3 at the bottom end and is in threaded engagement with a toothed wheel 5 in the gear box 6 in the middle telescopic part 2 (best seen in FIG. 3).

The adjusting screw (or spindle) 7 is turnable in relation to the middle telescopic part 2 and in treaded engagement with the nut 8, which is attached to the telescopic part 1. The adjusting screw 7 is attached to a toothed wheel 10, and both the wheels 5, 10 are in engagement with the driving toothed wheel 11 in the gearbox 6 (best seen in FIG. 3). The driving toothed wheel 11 is attached to a driving shaft 12 extending downwards through the middle telescopic part 2. The driving shaft 12 is attached to a transmission pipe 13, the driving toothed wheel 11 thus being driven by an external power source (not shown) via the driving shaft 12 and the transmission pipe 13.

As can be seen, the middle telescopic part 2 and the second telescopic part 1 will be moved synchronously upwards and downwards upon rotation of the driving shaft 12 meaning that the device obtains a small building-in height in relation to the travel of the telescopic parts.

FIG. 3 shows a top view of a telescopic device with a gearbox 6 comprising the three toothed wheels 5, 10 and 11. The gearbox 6 is positioned in the bottom end of the middle telescopic part 2 that is telescopically engaged in the first 1 and second telescopic part 3. The driving shaft 12 is attached to the driving toothed wheel 11, the adjusting screw 4 is in threaded engagement with the toothed wheel 5, and the adjusting screw 7 is attached to the toothed wheel 10.

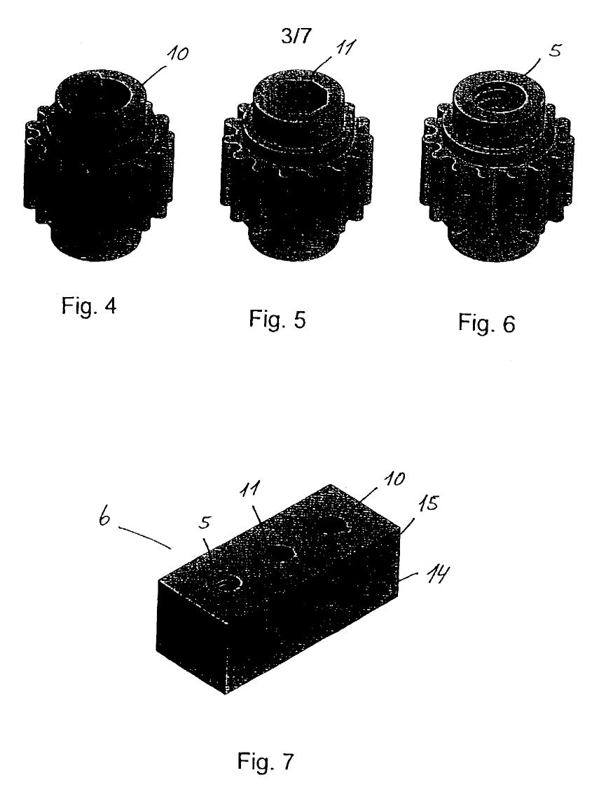

FIGS. 4-6 show the toothed wheels 5, 10 ,11 according to the invention. The toothed wheel 5 comprises an internal thread, so that the wheel can be displaced about the longitudinal axis of the first adjusting screw 4, which comprises an external thread (a spindle). The driving toothed wheel 11 comprises a hole with a cross-section that fits to the cross-section of the driving shaft 12. The toothed wheel 10 comprises a groove for attaching the adjusting screw 7 to the wheel by means of a wedge.

FIG. 7 shows the gearbox 6 with the toothed wheel 5, 10 and 11 mounted in a housing with a bottom part 14 and a top part 15.

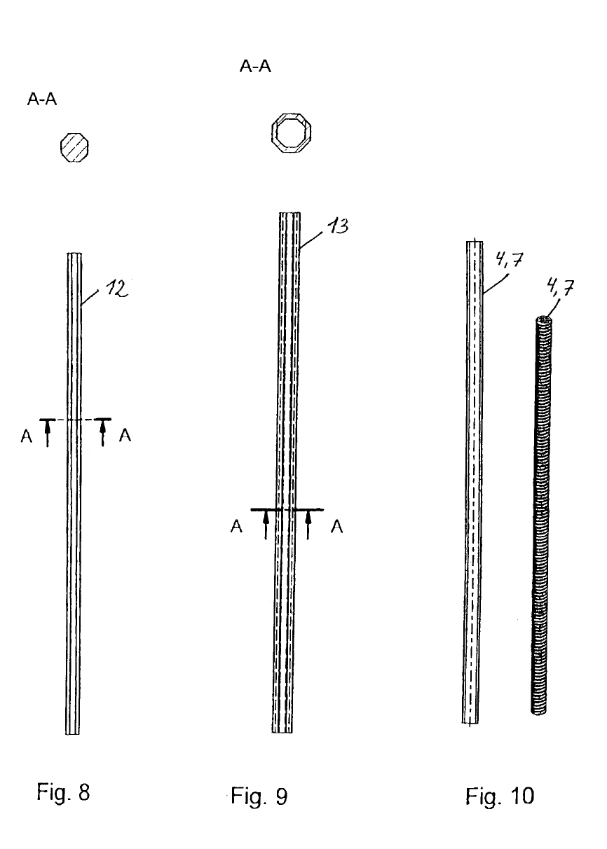

FIG. 8 shows the driving shaft 12. FIG. 9 shows the transmission pipe 13. FIG. 10 shows the two adjusting screws 4,7.

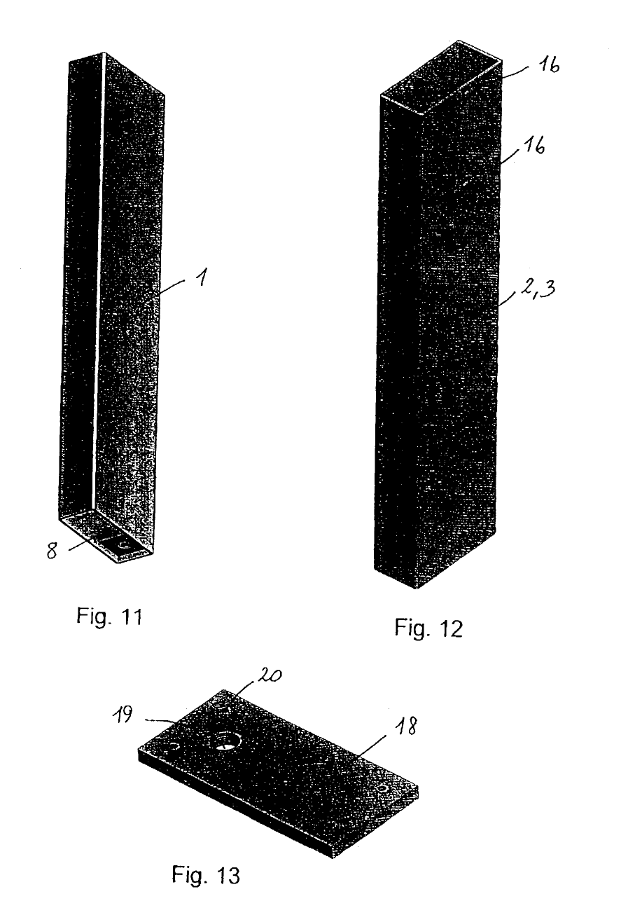

FIG. 11 show the second telescopic part 1 comprising the nut 8 positioned in the bottom part thereof.

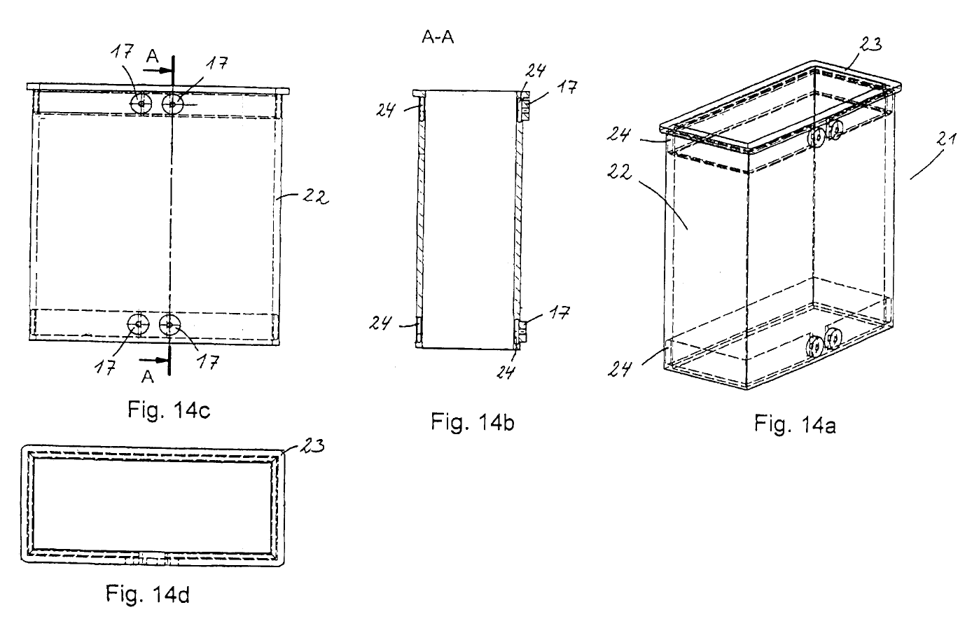

FIG. 12 shows the middle telescopic part 2 (the first telescopic part 3 is similar) comprising holes 16 for receiving the pipe stubs 17 of the sleeves (see FIGS. 14a-d ).

FIG. 13 shows a bottom plate 18 for the first telescopic part 3. The adjusting screw 4 is mounted in the hole 19 of the plate. The plate further comprises holes 20 for mounting the telescopic device to a floor or to a supporting foot/base.

FIGS. 14a-d show a sleeve 21 comprising sidewalls 22, an upper edge portion 23 and expansible channels 24. The channels are expanded by filling foamed plastic (or another expansible material) in through the pipe stubs 17.

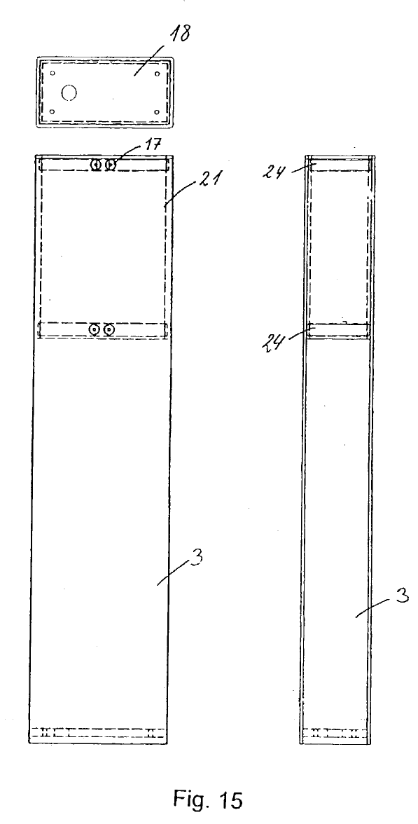

FIG. 15 shows a first telescopic part (3) with a sleeve 21 positioned in its upper portion. The sleeve 21 fits into the telescopic part and has an inner cross-section that fits to the outer cross-section of the middle telescopic part 2, which is to be telescopically engage therein. The pipe stubs 17 extend through the holes 16 provided in the telescopic part. When the middle telescopic part is fitted into the sleeve and first telescopic part, an expansible material is filled into the channels 24, so that the channels exert a pressure on the outer side portion of the middle telescopic part. Thus, the clearance between the two telescopic parts is reduced to a minimum.

1. A bar or column shaped telescopic device comprising:
at least three telescopic parts with a first part, a middle part and a second part, the telescopic parts being in telescopic engagement with each other,
a first and a second adjusting screw extending inside the telescopic parts, the first adjusting screw being connected to the first telescopic part and in threaded engagement with a nut mounted onto the middle telescopic part in such a way that said nut is turnable about the longitudinal axis of the first adjusting screw, while the second adjusting screw is connected to but turnable in relation to the middle telescopic part and in threaded engagement with the second telescopic part, and
driving means for rotating the nut and the second adjusting screw simultaneously.

2. A telescopic device according to claim 1, wherein the three telescopic parts are substantially of the same length.

3. A telescopic device according to claim 1 or 2, and having a telescopic driving shaft extending into the telescopic parts in the longitudinal direction and connecting the driving means to a power source provided outside the telescopic parts.

4. A telescopic device according to any of the claims 1-3, wherein the driving means comprise a driving part arranged in the middle telescopic part, the driving part being in driving engagement with the nut and the second adjusting screw.

5. A telescopic device according to claim 4, wherein the nut has the form of a first toothed wheel, and wherein one end of the second adjusting screw is attached to a second toothed wheel, the driving part comprising a driving toothed wheel in direct or indirect engagement with the first and/or the second toothed wheel.

6. A telescopic device according to any of the claims 3-5, wherein the telescopic driving shaft comprises parts in telescopic engagement with each other and with complementary inner and outer, respectively, non-circular, preferably edged, cross sections.

7. A telescopic device according to any of the preceding claims, wherein the driving means is arranged inside and at one end of the middle telescopic part.

8. A telescopic device according to any of the preceding claims, comprising four, five, six, seven or several telescopic parts in telescopic engagement with each other and further nuts, adjusting screws and driving means and one or more further driving shafts.

9. A telescopic device according to any of the preceding claims, wherein the telescopic parts have an outer non-circular, preferably edged, cross section or oval shaped cross section.

10. A telescopic device according to any of the preceding claims, wherein the telescopic parts have inner and outer recesses, respectively, in telescopic-engagement with each other, such as one or more slots preventing the telescopic parts from rotating in relation to each other.

11. A telescopic device according to any of the claims 3-10, wherein the power source drives the driving shaft(s) manually or electrically or pneumatically.

12. A telescopic device according to any of the preceding claims, wherein the nut(s) and the second adjusting screw(s) are driven by separate power sources.

13. A telescopic device according to any of the preceding claims, further comprising sleeves extending along at least a part of the outer surface of the second and middle telescopic part, respectively, and fitting into the middle and first telescopic part, respectively.

14. A telescopic device according to claim 13, wherein each sleeve comprises one or more expansible tube-like channels arranged on one or more of its sides.

15. A telescopic device according to claim 14, wherein the channels are arranged circumferentially in an upper and/or lower portion of each sleeve.

16. A telescopic device according to claim 14 or 15, wherein each channel is expanded by means of an expansible material, such as foamed plastic, filled into the channel.

17. A telescopic device according to claim 16, wherein the expansible material is filled in through pipe stubs provided in the end(s) of the channel.

18. A telescopic device according to claim 14 or 15, wherein each channel is expanded by means of heating or by mixing reagents within the channel.

19. A telescopic device according to any of claims 13-18, wherein the sleeves are made of a flexible material, such as plastic.
